(19) United States
(12) Patent Application Publication
(10) Pub. No.: US 2022/0237916 A1
(43) Pub. Date: Jul. 28, 2022

(54) METHOD FOR DETECTING COLLISIONS IN VIDEO AND ELECTRONIC DEVICE

(71) Applicant: BEIJING DAJIA INTERNET INFORMATION TECHNOLOGY CO., LTD., Beijing (CN)

(72) Inventor: Yi XIAO, Beijing (CN)

(21) Appl. No.: 17/537,023

(22) Filed: Nov. 29, 2021

(30) Foreign Application Priority Data
Jan. 22, 2021 (CN) 202110088532.5

(51) Int. Cl. G06V 20/40; G06T 11/00; G06T 7/12; G06T 7/246; G06V 10/46

(52) U.S. Cl. CPC G06V 20/44; G06T 11/00; G06T 7/12; G06T 7/248; G06V 10/46; G06V 2201/07; G06T 2207/10016; G06T 2207/20068; G06T 2210/12; G06T 2210/21; G06V 20/46

(57) ABSTRACT

A method for detecting collisions in a video is provided. In the method, first bounding boxes of dynamic virtual elements are acquired, wherein the dynamic virtual elements are added into a video picture; target contour points corresponding to an original target object in the video picture are identified, wherein the target contour points are positioned on a contour line of the original target object; one second bounding box is created based on each two adjacent target contour points of the original target object; and the collisions between the first bounding boxes and the second bounding boxes are detected. A device and a computer-readable storage medium are further provided.

### CROSS-REFERENCE TO RELATED APPLICATION

This application is based on and claims priority to Chinese Patent Application No. 202110088532.5, filed on Jan. 22, 2021, the disclosure of which is herein incorporated by reference in its entirety.

### TECHNICAL FIELD

The present disclosure relates to the field of video processing technologies, and in particular, relates to a method for detecting and determining collisions in a video and an electronic device.

### BACKGROUND

Collision detection refers to the detection of collisions between objects, such as detecting contacts or penetrations between the objects. It is an important research topic in the fields such as computer graphics, virtual reality, computer games, animation, robots, and virtual manufacturing.

### SUMMARY

Embodiments of the present disclosure provide a method for detecting collisions in videos and an electronic device.

According to one aspect of the embodiments of the present disclosure, a method for detecting collisions in a video is provided. The method includes:

acquiring first bounding boxes of dynamic virtual elements, wherein the dynamic virtual elements are added into a video picture;

identifying target contour points corresponding to an original target object in the video picture, wherein the target contour points are positioned on a contour line of the original target object;

creating one second bounding box based on each two adjacent target contour points of the target contour targets; and

detecting the collisions between the first bounding boxes and the second bounding boxes.

According to another aspect of the embodiments of the present disclosure, an electronic device is provided. The electronic device includes:

one or more processors;

a volatile or non-volatile memory configured to store one or more instructions executable by the one or more processors,

wherein the one or more processors, when loading and executing the one or more instructions, are caused to perform:

acquiring first bounding boxes of dynamic virtual elements, wherein the dynamic virtual elements are added into a video picture;

identifying target contour points corresponding to an original target object in the video picture, wherein the target contour points are positioned on a contour line of the original target object;

creating one second bounding box based on each two adjacent target contour points of the target contour targets; and

detecting collisions between the first bounding boxes and the second bounding boxes.

According to still another aspect of the embodiments of the present disclosure, a computer-readable storage medium storing one or more instructions therein is provided. The one or more instructions, when loaded and executed by a processor of an electronic device, cause the electronic device to perform:

acquiring first bounding boxes of dynamic virtual elements, wherein the dynamic virtual elements are added into a video picture;

identifying target contour points corresponding to an original target object in the video picture, wherein the target contour points are positioned on a contour line of the original target object;

creating one second bounding box based on each two adjacent target contour points of the target contour targets; and

detecting collisions between the first bounding boxes and the second bounding boxes.

It is to be understood that both the above general description and the following detailed description are exemplary and explanatory only and are not intended to limit the present disclosure.

### BRIEF DESCRIPTION OF THE DRAWINGS

FIG. 1 illustrates a schematic diagram of an implementation environment according to an embodiment of the present disclosure;

FIG. 2 illustrates a flow chart of a method for detecting collisions in a video according to an embodiment of the present disclosure;

FIG. 3 illustrates a flow chart of a method for detecting collisions in a video according to an embodiment of the present disclosure;

FIG. 4 illustrates a video picture containing an original target object according to an embodiment of the present disclosure;

FIG. 5 illustrates a schematic diagram of a mask corresponding to an original target object according to an embodiment of the present disclosure;

FIG. 6 illustrates a schematic diagram of a process of searching for all original contour points in a mask according to an embodiment of the present disclosure;

FIG. 7 illustrates a schematic diagram of a process of searching for an end point in a mask according to an embodiment of the present disclosure;

FIG. 8 illustrates a schematic diagram of pixel points in eight neighborhoods of an original contour point according to an embodiment of the present disclosure;

FIG. 9 illustrates a schematic diagram of a process of searching for a second original contour point in a mask according to an embodiment of the present disclosure;

FIG. 10 illustrates a schematic diagram of a contour of an original target object according to an embodiment of the present disclosure;

FIG. 11 illustrates a schematic diagram of a bounding box bounding an original target object according to an embodiment of the present disclosure;

FIG. 12 illustrates a schematic diagram of a plurality of bounding boxes fitting an original target object according to an embodiment of the present disclosure;

FIG. 13 illustrates a schematic diagram of a single bounding box created based on adjacent contour points according to an embodiment of the present disclosure;

FIG. 14 illustrates a schematic directional diagram according to an embodiment of the present disclosure;

FIG. 15 illustrates a block diagram of an apparatus for detecting collisions in a video according to an embodiment of the present disclosure;

FIG. 16 illustrates a schematic structural diagram of a terminal according to an embodiment of the present disclosure; and

FIG. 17 illustrates a schematic structural diagram of a server according to an embodiment of the present disclosure.

### DETAILED DESCRIPTION

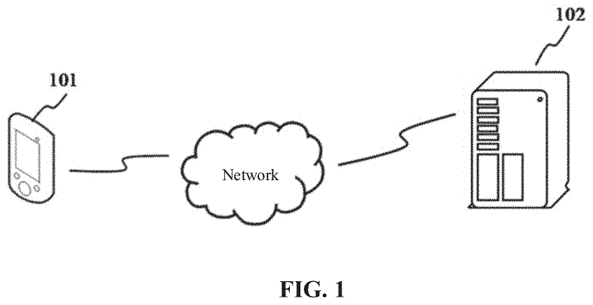

FIG. 1 illustrates a schematic diagram of an implementation environment according to an embodiment of the present disclosure. Referring to FIG. 1, the implementation environment includes a terminal 101 and a server 102. The terminal 101 and the server 102 are connected via a wireless or wired network. For example, the terminal 101 is a computer, a mobile phone, a tablet computer, or other terminals. For example, the server 102 is a background server of a target application or a cloud server that provides services such as cloud computing and cloud storage.

In some embodiments, the target application served by the server 102 is installed on the terminal 101, and the terminal 101 is capable of implementing functions such as data transmission and message interaction through the target application. For example, the target application is a target application in an operating system of the terminal 101, or a target. application provided by a third party. The target application includes a function of collision detection, i.e., the capability of detecting whether an original target object in a video picture collides with dynamic virtual elements added into the video picture. The target application may also have other functions, which are not limited in the embodiments of the present disclosure. For example, the target application is a short video application, a navigation application, a game application, a chat application or other applications, which is not limited in the embodiments of the present disclosure.

In the embodiment of the present disclosure, the server 102 is configured to detect collision between the original target object in the video picture and the dynamic virtual elements added into the video picture, determine other virtual elements based on a collision detection result; and send other virtual elements to the terminal 101, which is configured to add the other virtual elements sent by the server 102 into the video picture.

The method for detecting the collisions in the video according to the embodiments of the present disclosure is applicable to any collision detection scenarios.

For example, in the case that the method for detecting the collisions in the video is applicable to a video playback scenario, in response to a video being played, collision detection is performed on an original target object in a current video picture and dynamic virtual elements are added into the video picture by the method for detecting the collisions in the video according to the embodiments of the present disclosure; and the video picture is rendered with special effects based on a collision detection result.

For another example, in the case that the method for detecting the collisions in the video is applicable to a game scenario, during the process of a game, collision detection is performed on an original target object in a game picture and dynamic virtual elements are added into the game picture by the method for detecting the collisions in the video according to the embodiments of the present disclosure; the current game picture is rendered with special effects based on a collision detection result.

For still another example, in the case that the method for detecting the collisions in the video is applicable to a live streaming scenario, during the process of live streaming, collision detection is performed on an original target object in a current live-streaming picture and dynamic virtual elements are added into the live-streaming picture by the method for detecting the collisions in the video according to the embodiments of the present disclosure; and the live-streaming picture is rendered with special effects based on a collision detection result.

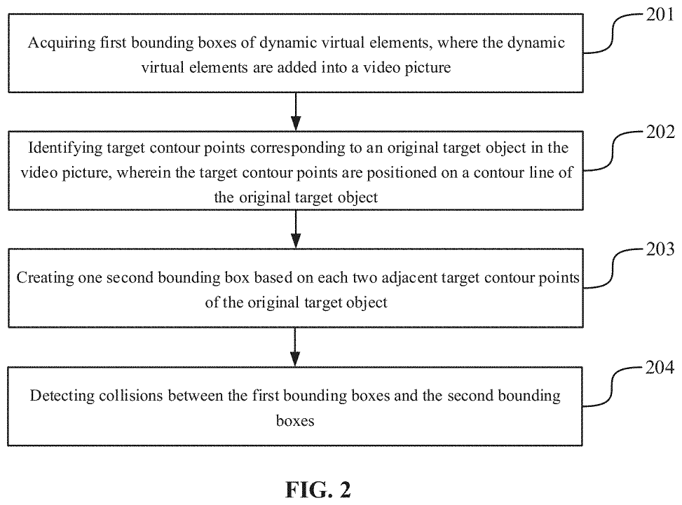

FIG. 2 illustrates a flow chart of a method for detecting collisions in a video according to an embodiment of the present disclosure. As shown in FIG. 2, the method for detecting the collisions in the video is applicable to an electronic device, and includes the following processes.

In 201, first bounding boxes of dynamic virtual elements are acquired, wherein the dynamic virtual elements are added into a video picture.

In 202, target contour points corresponding to an original target object in the video picture are identified, wherein the target contour points are positioned on a contour line of the original target object.

In 203, one second hounding box is created based on each two adjacent target contour points of the original target object.

In 204, collisions between the first hounding boxes and the second bounding boxes is detected.

In the technical solution according to the embodiment of the present disclosure, one bounding box is created based on each two adjacent target contour points of the target contour targets, and then a plurality of bounding boxes may be created for the original target object. The plurality of bounding boxes may well fit the contour of the original target object. Therefore, based on a result of the collision detection performed on the plurality of bounding boxes, whether the original target object collides with the dynamic virtual elements in the video picture can be accurately reflected, which ensures the accuracy of the collision detection result and improves the precision of the collision detection.

In some embodiments, the method for detecting the collisions in the video further includes:
determining that the dynamic virtual elements collide with the original target object in response to the first bounding boxes colliding with any one of the second bounding boxes.

In some embodiments, said identifying the target contour points corresponding to the original target object in the video picture includes:
determining pixel points satisfying a contour condition in the video picture as original contour points; and
extracting a second reference number of the target contour points every a first reference number of the original contour points.

In some embodiments, said determining the pixel points satisfying the contour condition in the video picture as the original contour points includes:
traversing the pixel points in the video picture;
determining a currently traversed pixel point as a first original contour point in response to the currently traversed pixel point being a pixel point corresponding to the original target object, and a previously traversed pixel point adjacent to the currently traversed pixel point being not the pixel point corresponding to the original target object; and
continuing to search for other original contour points based on the first original contour point.

In some embodiments, continuing to search for the other original contour points based on the first original contour point includes:
traversing pixel points along a first reference direction from any one of the pixel points, among pixel points in eight neighborhoods of the first original contour point, and determining a currently traversed pixel point satisfying the contour condition as an end point;
traversing the pixel points along a second reference direction from a first pixel point, among the pixel points in the eight neighborhoods of the currently determined original contour point, and determining a currently traversed pixel point satisfying the contour condition as a second original contour point, wherein the first pixel point is a pixel point reached by moving along the second reference direction from the end point, among the pixel points in the eight neighborhoods of the first original contour point; and
performing the following processes cyclically:
traversing the pixel points along the second reference direction from a second pixel point, among the pixel points in the eight neighborhoods of the currently determined original contour point, determining a currently traversed pixel point satisfying the contour condition as a next original contour point, and stopping the cycles in response to the determined next original contour point being the end point, wherein the second pixel point is a pixel point reached by moving along the second reference direction from a previous original contour point, among the pixel points in the eight neighborhoods of the currently determined original contour point,
wherein the first reference direction and the second reference direction are a clockwise or counterclockwise direction, and the second reference direction is different from the first reference direction.

In some embodiments, continuing to search for the other original contour points based on the first original contour point includes:
traversing pixel points along a first reference direction from any one of the pixel points, among pixel points in eight neighborhoods of the first original contour point, and determining a currently traversed pixel point satisfying the contour condition as a second original contour point, wherein the first reference direction is a clockwise or counterclockwise direction; and
performing the following processes cyclically:
traversing the pixel points along the first reference direction from a second pixel point, among the pixel points in the eight neighborhoods of the currently determined original contour point, determining a currently traversed pixel point, satisfying the contour condition, as a next original contour point, and stopping the cycles in response to the currently traversed pixel point being the first original contour point, wherein the second pixel point is a pixel point reached by moving along the second reference direction from a previous original contour point, among the pixel points in the eight neighborhoods of the currently determined original contour point.

In some embodiments, identifying the target contour points corresponding to the original target object in the video picture includes:
binarizing the video picture to acquire a mask, wherein pixel values of pixel points corresponding to the original target object in the mask are defined as first pixel values; and
identifying the target contour points among the pixel points of the mask.

In some embodiments, creating one second bounding box based on each two adjacent target contour points of the target contour targets includes:
determining a distance between two adjacent target contour points as a first side length of a rectangle, and determining a reference distance as a second side length of the rectangle; and
creating one second bounding box in a rectangular shape based on the first side length and the second side length, wherein the two adjacent target contour points are respectively disposed at center positions of opposite sides of the second bounding box.

In some embodiments, acquiring the first bounding boxes of the dynamic virtual elements includes:
identifying reference contour points corresponding to the dynamic virtual elements, wherein the reference contour points are positioned on a contour line of the dynamic virtual elements;
creating one first bounding box based on each two adjacent reference contour points; and
detecting the collisions between the first bounding boxes and the second bounding boxes includes:
detecting the collisions between any one of the first bounding boxes and any one of the second bounding boxes.

In some embodiments, detecting the collisions between the first bounding boxes and the second bounding boxes includes:
determining a direction perpendicular to a direction of each side of each of the first bounding boxes, and a direction perpendicular to a direction of each side of each of the second bounding boxes;
projecting the first bounding boxes and the second bounding boxes into each of the determined directions; and
determining that the first bounding boxes collide with the second bounding boxes in response to first projection regions and second projection regions being overlapped in each of the directions, wherein the first projection regions are defined as projection regions of the first bounding boxes; and the second projection regions are defined as projection regions of the second bounding boxes.

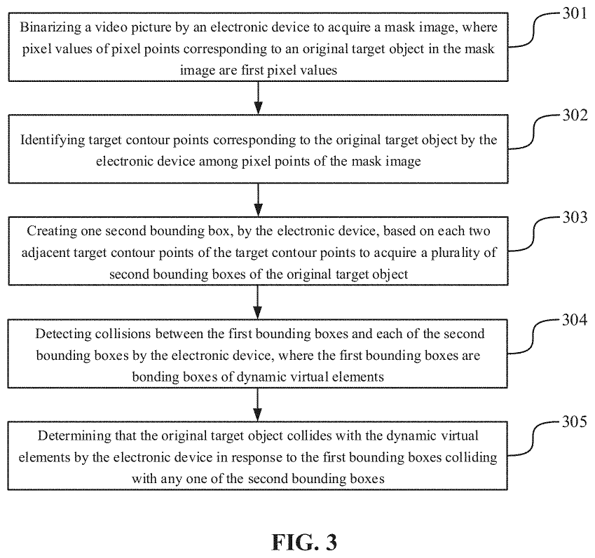

FIG. 3 illustrates a flow chart of a method for detecting collisions in a video according to an embodiment of the present disclosure. As shown in FIG. 3, the method for detecting the collisions in the video is executed by an electronic device, and includes the following processes.

In 301, the electronic device binarizes a video picture to acquire a mask, wherein pixel values of pixel points corresponding to an original target object in the mask are first pixel values.

The video picture contains the original target object. In terms of a source of the video picture, for example, the video picture is a video picture sent from another electronic device, or the video picture is a picture of a video stored in the electronic device. In terms of a type of video picture, for example, the video picture includes a frame of picture in a short video, a frame of picture in a game, etc. In terms of a content of the video picture, the video picture includes the original target object and the dynamic virtual elements. The video picture may further include other contents.

It should be noted that the original target object refers to a target object originally contained in the video picture. For example, the video picture is shot for the original target object, such that the video picture is to include the original object. For example, in the case that a video is shot for an individual, the individual is to be included in a video picture. The original target object may be various objects such as animals, vehicles, etc., which are not limited in the embodiments of the present disclosure.

In some embodiments, the dynamic virtual elements in the video picture are rendered into the video picture in real time. For example, a local electronic device or other electronic devices may process the video picture in response to acquiring the video picture, and may add the dynamic virtual elements into the video picture based on some features in the video picture during processing. For example, various image stickers may be added into the video picture. In addition, positions of the added dynamic virtual elements in the video picture are changeable. That is, the positions of the dynamic virtual elements in each frame of the video picture are different. Therefore, the dynamic virtual elements may collide with the original target object in the video picture. In the embodiment of the present disclosure, whether the dynamic virtual elements collide with the original target object may be detected, and in the case that a collision occurs, special effect may be applicable to the video picture, such as adding other virtual elements related to the collisions into the video picture.

The binarization of the video picture is to set a gray value of the pixel points in the video picture to two values, for example, 0 and 255. That is, the entire video picture is presented with an obvious visual effect of only black and white.

A mask image is a binarized image, and a pixel value of any pixel point in the mask is either a first pixel value or a second pixel value. In the case that the pixel value of a pixel point is the first pixel value, the pixel point is a pixel point corresponding to the original target object; and in the case that the pixel value of a pixel point is the second pixel value, the pixel point is not the pixel point corresponding to the original target object.

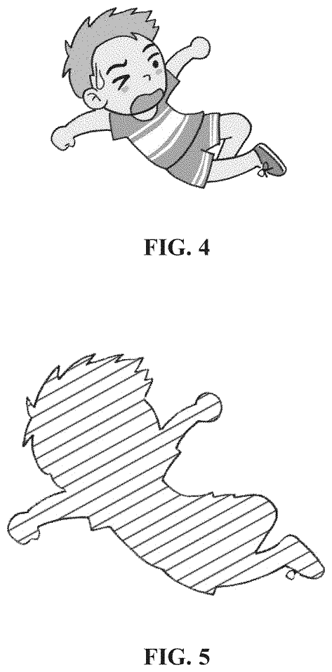

For example, the implementation of the electronic device to binarize a video picture to acquire a mask is as follows. The electronic device calls an image segmentation model, and segments images of the video picture to acquire a picture region where an original target object in the video picture is located, and sets the pixel value of each pixel point in the picture region to the first pixel value, and sets the pixel value of each pixel point in other regions to the second pixel value to acquire the mask. Referring to FIGS. 4 and 5, FIG. 4 illustrates a video picture without binarization, and FIG. 5 illustrates a mask acquired upon the binarization of the video picture. A region covered by stripes in the mask in FIG. 5 represents the picture region where the original target object is located, and the pixel value of each of the pixel points in the picture region is the first pixel value, and the pixel value of each of the pixel points in other regions in the mask is the second pixel value.

In the embodiment of the present disclosure, the video picture containing the original target object is binarized to acquire the mask. Because the mask only contains the pixel points with two types of pixel values, i.e., the pixel points corresponding to the original target object with the first pixel value as the pixel value and other pixel points with the other pixel value as the pixel value, it is easy to distinguish the pixel points corresponding to the original target object from other pixel points with differences in pixel value, which ensures the accuracy in identifying the target contour points from the mask.

In 302, the electronic device identifies, from pixel points of the mask, the target contour points corresponding to the original target object.

The original target object corresponds to a plurality of pixel points, some of which are disposed on a contour line of the original target object, and these pixel points are the contour points corresponding to the original target object. Herein, the target contour points are all or part of the contour points on the contour line.

In some embodiments, identifying the target contour points corresponding to the original target object from the pixel points of the mask by the electronic device includes: the electronic device traverses the pixel points of the mask, searches for pixel points satisfying a contour condition from the pixel points of the mask, and determines the searched pixel points as the original contour point. That is, the electronic device determines pixel points satisfying a contour condition in the video picture as original contour points. Then, the electronic device acquires a plurality of target contour points corresponding to the original target object by extracting a second reference number of the target contour points from the searched original contour points every a first reference number of the original contour points. Herein, the first reference number and the second reference number are arbitrary numerical values. For example, the first reference number is 10 and the second reference number is 1. This is not limited in the embodiment of the present disclosure.

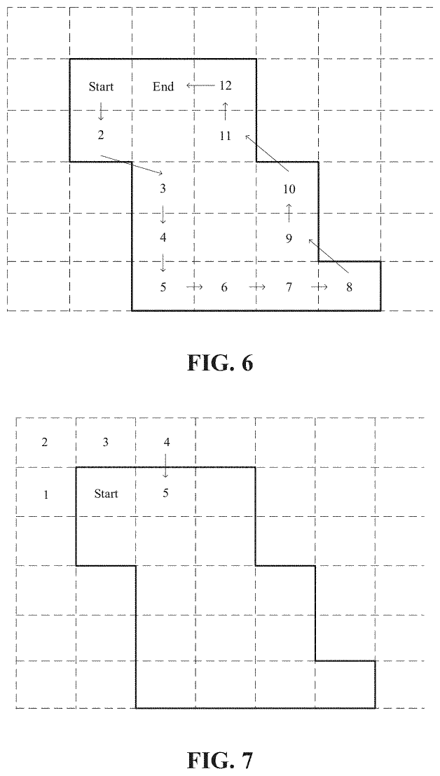

The pixel points satisfying the contour condition indicate that the pixel points corresponds to the original target object.; and among pixel points adjacent to these pixel points, at least one pixel point is not corresponding to the original target object. Referring to FIG. 6, each grid represents a pixel point; a region bounded by lines represents a region corresponding to the original target object; a position of this region in the mask is the same as a position of the original target object in the video picture; and each grid in this region represents a pixel point corresponding to the original target object. In this region, the pixel points marked with “Start,” “End” or numbers are all the pixel points corresponding to the original target object and correspond to contour line of the original target object; and among the pixel points adjacent to each of these pixel points, at least one pixel point is not the pixel point corresponding to the original target object. Therefore, the pixel points marked with “Start,” “End” or numbers are the original contour points corresponding to the original target object.

In the embodiment of the present disclosure, in the case that the target contour points are extracted, it is necessary to create a plurality of bounding boxes based on the extracted target contour points, and perform collision detection based on the bounding boxes. Therefore, in the case that the original contour points satisfying the contour condition are searched from the pixel points of the mask, extracting the target contour points every a number of the original pixel points may reduce the number of extracted target contour points and the number of bounding boxes to be created, which greatly improves the efficiency of collision detection.

In some embodiments, determining the pixel points satisfying the contour condition in the video picture as the original contour points by the electronic device include: traversing the pixel points in the mask by the electronic device, and determining the currently traversed pixel point as a first original contour point in response to the currently traversed pixel point being a pixel point corresponding to the original target object, and a previously traversed pixel point adjacent to the currently traversed pixel point being not the pixel point corresponding to the original target object; and continuing to search for other original contour points based on the first original contour point by the electronic device.

For example, a method for traversing the pixel points in the mask by the electronic device includes: traversing the pixel points in the mask by the electronic device in a left-to-right and top-to-bottom order; and determining the currently traversed pixel point as the first original contour point in the case that the currently traversed pixel point is a pixel point corresponding to the original target object, and a previously traversed pixel point adjacent to the currently traversed pixel point is not the pixel point corresponding to the original target object. The electronic device may also traverse the pixel points in the mask in another order, for example, in the right-to-left and bottom-to-top order, which is not limited in the embodiment of the present disclosure.

In the embodiment of the present disclosure, because the original contour points are searched by traversing the pixel points, the currently traversed pixel point is determined to be a contour point in response to the currently traversed pixel point being a pixel point corresponding to the original target object, and a previously traversed pixel point adjacent to the currently traversed pixel point being not the pixel point corresponding to the original target object. Therefore, searching for the first original contour point by the method described above ensures the accuracy of the determined first original contour point. In addition, considering the correlation between the positions of the contour points, continuing to search for the other original contour points based on the first original contour point may improve the. efficiency of searching for other original contour points.

In some embodiments, two methods are available for the electronic device to continue to search for the other original contour points based on the first original contour point. The first method includes the following processes (1) to (3).

In process (1), the electronic device traverses pixel points along a first reference direction from any one of the pixel points, among pixel points in eight neighborhoods of the first original contour point, and determines a currently traversed pixel point satisfying the contour condition as an end point.

The first reference direction is a clockwise or counterclockwise direction. Referring to FIG. 7, in response to determining that the first original contour point is the pixel point marked with “Start” and the first reference direction is the clockwise direction, the pixel points are traversed along the clockwise direction from a pixel point marked with a number 4, among the pixel points in the eight neighborhoods of the first original contour point. A currently traversed pixel point satisfying the contour condition is a pixel point marked with a number 5, and this pixel point is the end point.

In process (2), the electronic device traverses the pixel points along a second reference direction from a first pixel point, among the pixel points in the eight neighborhoods of the first original contour point, and determines a currently traversed pixel point, satisfying the contour condition, as a second original contour point.

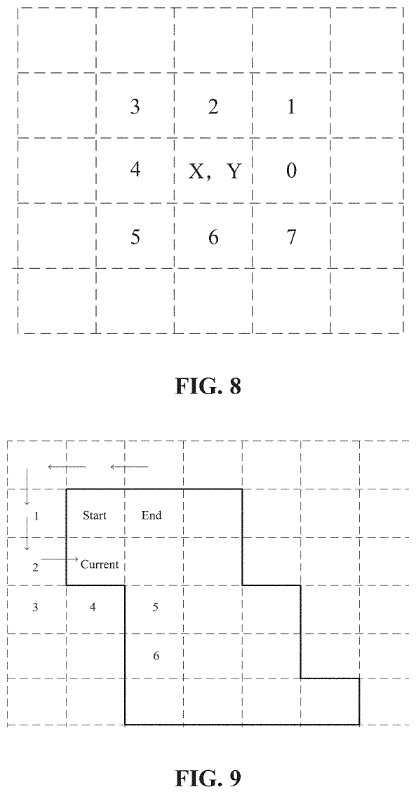

The second reference direction is a clockwise or counterclockwise direction, and the second reference direction is different from the first reference direction. The first pixel point is a pixel point reached by moving along the second reference direction from the end point, among the pixel points in the eight neighborhoods of the first original contour point. The pixel points in the eight neighborhoods of the first original contour point indicate that eight pixel points around the first original contour point. Referring to FIG. 8, in the case that a pixel point marked with “X, Y” is the first original contour point, the eight pixel points marked with numbers around the first original contour point are the pixel points in the eight neighborhoods of the first original contour point.

In some embodiments, referring to FIG. 9, in the case that the pixel point marked with “Start” is the first original contour point, the pixel point marked with “End” is the end point, and the second reference direction is the counterclockwise direction, the first pixel point is a pixel point reached by moving along the counterclockwise direction from the end point, among the pixel points in the eight neighborhoods of the pixel point marked with “Start.” In response to the pixel points in the eight neighborhoods of the pixel point marked with “Start” being traversed along the counterclockwise direction from the first pixel point, and a currently traversed pixel point satisfying the contour condition being the pixel point marked with “Current,” the electronic device determines the pixel point marked with “Current” as a second original contour point.

In process (3), the electronic device performs the following processes cyclically:
traversing the pixel points along the second reference direction from the second pixel point, among the pixel points in the eight neighborhoods of the currently determined original contour point; determining a currently traversed pixel point, satisfying the contour condition, as a next original contour point; and stopping the cycles in response to the determined next original contour point, being the end point.

The second pixel point is a pixel point reached by moving along the second reference direction from a previous original contour point, among the pixel points in the eight neighborhoods of the currently determined original contour point. Because the electronic device has just determined the second original contour point, in this step, the currently determined original contour point in the first cycle is the second original contour point, and the previous original contour point is the first original contour point.

For example, still referring to FIG. 9, in the case that the pixel point marked with “Start” is the first original contour point, the pixel point marked with “End” is the end point, the pixel point marked with “Current” is the second original contour point, and the second reference direction is the counterclockwise direction, the second pixel point in a first cycle, i.e., the pixel point marked with “1” is a pixel point reached by moving along the counterclockwise direction from the pixel point marked with “Start” among the pixel points in the eight neighborhoods of the pixel point marked with “Current.” In this case, the electronic device traverses the pixel points along the counterclockwise direction from the pixel point marked with 1, among the pixel points in the eight neighborhoods of the pixel point marked with “Current;” then, the currently traversed pixel point satisfying the contour condition is the pixel point marked with 5; and the pixel point marked with 5 is the next original contour point, i.e., the third original contour point.

In the case that the electronic device determines the pixel point marked with 5 as the third original contour point, the second cycle of step (3) is entered. In this way, the third original contour point is the currently determined original contour point, and the second original contour point becomes the previous original contour point. Afterwards, the electronic device continues to determine the next original contour point in the same fashion as determining the third original contour point, and so on, until the determined next original contour point is the end point.

Still referring to FIG. 6, in response to the pixel point marked with “Start” being the first original contour point, the pixel point marked with “End” being the end point, the pixel point marked with 2 being the second original contour point, and the second reference direction being the counterclockwise direction, the electronic device is to sequentially determine each of the original contour points in an order marked by the arrow, until the determined next original contour point is the end point marked with “End.” That is, the electronic device sequentially determines the remaining original contour points according to the following order 3, 4, 5, 6, 7, 8, 9, 10, 11, 12, and “End” marked by the pixel points.

In the embodiment of the present disclosure, considering that an edge of the original target object is continuous, two conjoint original contour points among the plurality of original contour points corresponding to the original target object are each other's pixel points in the eight neighborhoods of each other. Accordingly, each time the pixel points in the eight neighborhoods of the currently determined original contour point are traversed from the second pixel point, and the currently traversed pixel point satisfying the contour condition is determined as the next original contour point, the remaining original contour points may be found sequentially without traversing each of the pixel points in the mask, which may greatly improve the efficiency in determining the original contour points.

In a first method for continuing to searching for the other original contour points based on the first original contour point, the end point is determined as the end point of the traversal; and in a second method for continuing to searching for the other original contour points based on the first original contour point, the first original contour point is determined as the end point of the traversal. The second method includes the following processes (A) and (B).

In process (A), the electronic device traverses the pixel points along a second reference direction from any one of the pixel points, among pixel points in eight neighborhoods of the first original contour point, and determines a currently traversed pixel point, satisfying the contour condition, as a second original contour point.

Still referring to FIG. 7, in the case that the determined first original contour point is the pixel point marked with “Start,” and the first reference direction is the counterclockwise direction, the pixel points are traversed along the counterclockwise direction from a pixel point marked with a number 4, among the pixel points in the eight neighborhoods of the first original contour point. A currently traversed pixel point satisfying the contour condition is a pixel point below the pixel point marked with “Start,” and this pixel point is the second original contour point.

In process (B), the electronic device performs the following processes cyclically:
traversing the pixel points along the first reference direction from a second pixel point, among the pixel points in the eight neighborhoods of the currently determined original contour point; determining a currently traversed pixel point, satisfying the contour condition, as a next original contour point; and stopping the cycles in response to the currently traversed pixel point being the first original contour point.

The second pixel point is a pixel point reached by moving along the first reference direction from a previous original contour point, among the pixel points in the eight neighborhoods of the currently determined original contour point. Because the electronic device has just determined the second original contour point, in this step, the currently determined original contour point in the first cycle is the second original contour point, and the previous original contour point is the first original contour point. Still referring to FIG, 7, in response to the pixel point marked with “Start” being the first original contour point, a pixel point below the pixel point marked with “Start” being the second original contour point, and the first reference direction being the counterclockwise direction, the second pixel point in a first cycle is a pixel point marked with 1.

Still referring to FIG. 6, in response to the pixel point marked with “Start” being the first original contour point, the pixel point marked with 2 being the second original contour point, and the first reference direction being the counterclockwise direction, the second pixel point in the first cycle is a pixel point, i.e., the pixel point on the left of the pixel point marked with 2, reached by moving along the counterclockwise direction from the pixel point marked with “Start” among the pixel points in the eight neighborhoods of the pixel point marked with “Current.” In this case, the electronic device traverses the pixel points along the counterclockwise direction from the pixel point on the left of the pixel point marked with “Start,” among the pixel points in the eight neighborhoods of the pixel point marked with “2.” Then, the currently traversed pixel point satisfying the contour condition is the pixel point marked with 3; and the pixel point marked with “3” is the next original contour point, i.e., the third original contour point. The electronic device is to sequentially determine each of the original contour points in the order marked by the arrow, until the currently traversed pixel point is the first original contour point marked with “Start.” That is, the electronic device sequentially determines the remaining original contour points according to the following order 4, 5, 6, 7, 8, 9, 10, 11, 12, and “End” marked by the pixel points. Referring to FIGS. 5 and 10, FIG. 10 illustrates a contour diagram of the original target object consisting of the original contour points. It is generated in the case of determining the original contour points based on the mask shown in FIG. 5.

In the embodiment of the present disclosure, considering that an edge of the original target object is continuous, two conjoint original contour points among the plurality of original contour points corresponding to the original target object are in each other's pixel points in the eight neighborhoods of each other. Accordingly, each time the pixel points in the eight neighborhoods of the currently determined original contour point are traversed from the second pixel point, and the currently traversed pixel point satisfying the contour condition is determined as the next original contour point, the remaining original contour points may be found sequentially without traversing each of the pixel points in the mask, which may greatly improve the efficiency in determining the original contour points.

It should be noted that acquiring the mask of the video picture and determining the target contour points corresponding to the original target object based on the mask are merely one of the methods for identifying the target contour points corresponding to the original target object. In other embodiments, the target contour points corresponding to the original target object are identified by other fashions, for example, the target contour points corresponding to the original target object are identified directly from the original video picture, which is not limited by the embodiment of the present disclosure. Herein, a method for directly identifying the target contour points corresponding to the original target object from the original video picture is the same as the method for identifying the target contour points corresponding to the original target object from the mask. The details are not repeated here.

In 303, one second bounding box is created, by the electronic device, based on each two adjacent target contour points of the target contour targets to acquire a plurality of second bounding boxes of the original target object. Based on the multiple target contour points of the original target object, a plurality of second bound boxes can be created.

The second bounding boxes are bounding boxes of the original target object. In some embodiments, creating one second bounding box based on each two adjacent target contour points of the target contour targets by the electronic device includes: determining, by the electronic device, a distance between two adjacent target contour points as a first side length of a rectangle, and determining a reference distance as a second side length of the rectangle; and creating one second bounding box in a rectangular shape based on the first side length and the second side length, wherein the two adjacent target contour points are respectively disposed at center positions of opposite sides of the second bounding box. The reference distance is set to any value as required, which is not limited in the embodiment of the present disclosure.

It should be noted that in the related art, the bounding box of the original target object is a region that is closest to the original target object, and all parts of the original target object are located in the bounding box. FIG. 11 illustrates a schematic diagram of a bounding box in the related art. Referring to FIG. 11, the original target object is an individual, which is completely disposed within the bounding box.

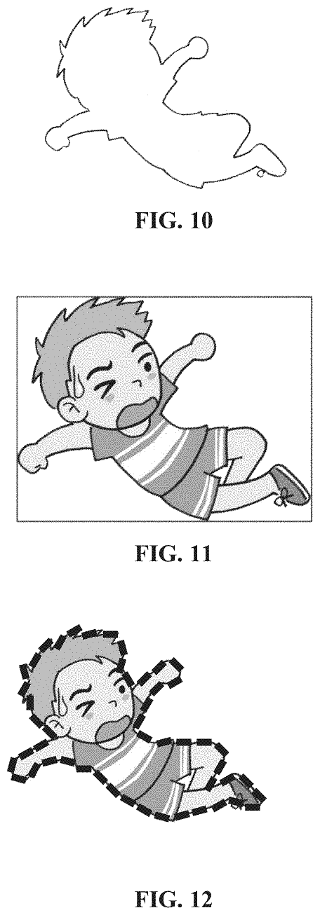

In the embodiment of the present disclosure, the original target object includes a plurality of bounding boxes, and each of the bounding boxes is created based on the adjacent target contour points of the original target object. Therefore, the plurality of bounding boxes may well fit a contour of the original target object. FIG. 12 illustrates a schematic diagram of bounding boxes according to an embodiment of the present disclosure. Referring to FIG. 12, the original target object is an individual, and rectangular region around the individual represents bounding boxes. The individual is provided with a plurality of bounding boxes, which accurately fit the contour of the individual.

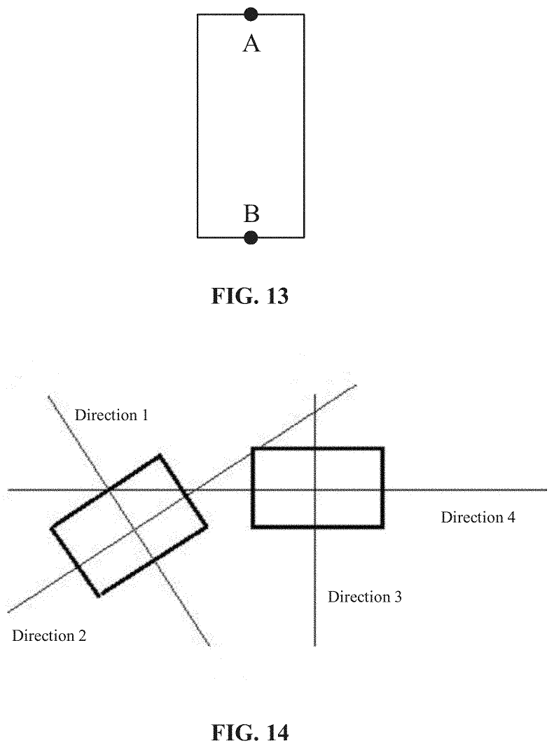

In the embodiment of the present disclosure, in the case that the hounding boxes are created based on each two adjacent target contour points of the target contour targets of the original target object, each of the bounding boxes is created as a rectangle, with the two adjacent target contour points respectively disposed at center positions of the opposite sides of the bounding box, which may ensure that the plurality of created bounding boxes are closer or closest to the contour of the original target object. FIG. 13 illustrates a schematic diagram of a bounding box. Referring to FIG. 13, the bounding box is a rectangle, and “A” and “B” are two adjacent target contour points, which are respectively disposed at the center positions of the opposite sides of the rectangle.

It should be noted that the contour of the original target object may be of any shape, and therefore, the bounding box in the embodiment of the present disclosure may be of any direction.

In 304, the electronic device detects collisions between the first bounding boxes and each of the second bounding boxes, wherein the first bounding boxes are bonding boxes of dynamic virtual elements.

That is, the electronic device performs the collision detection on the first bounding boxes and any one of the second bounding boxes. The dynamic virtual elements are the elements added into the video picture. In some embodiments, the dynamic virtual elements are movable virtual elements added into the video picture. Because the positions of the dynamic virtual elements in the video picture are to change, the dynamic virtual elements may collide with the original target object in the video picture. Therefore, it is necessary to detect whether the dynamic virtual elements collide with the original target object. In some embodiments, the dynamic virtual elements are stickers with various images, which is not limited in the embodiment of the present disclosure.

The collision detection refers to the detection of whether the bounding boxes of the dynamic virtual elements collide with the bounding boxes of the original target object. The collision detection includes the following processes (C) and (D).

In process (C), the electronic device determines a direction perpendicular to a direction of each side of each of the second bounding boxes (e.g., the bounding box of the original target object), respectively; and a direction perpendicular to a direction of each side of each of the first bounding boxes (e.g., the bounding box of the dynamic virtual elements), respectively. The two directions of the second bounding boxes are defined as a second direction and the two directions of the first bounding boxes are defined as the first direction.

Referring to FIG. 14, the two rectangles respectively represent the bounding box of the original target object and the bounding box of the dynamic virtual elements, and a direction 1, a direction 2, a direction 3, and a direction 4 are four directions determined by the electronic device. In one example, the direction 1 and the direction 2 are the first direction of a first bounding box, and the direction 3 and the direction 4 are the second direction of a second bounding box.

In process (D), the electronic device projects the second bounding boxes and the first bounding boxes to the first direction and the second direction, respectively, and determines that the second bounding boxes collide with the first bounding boxes in response to the second projection regions of the second bounding box and first projection regions of the first bounding box being overlapped in both the first direction and the second direction. That is, the electronic device projects the second bounding boxes and the first bounding boxes to each of the determined directions, and determines that the first bounding boxes collide with the second bounding boxes in response to the first projection regions and the second projection regions being overlapped in each of the directions. The first projection regions are defined as projection regions of the first bounding boxes; and the second projection regions are defined as projection regions of the second bounding boxes. In the example illustrated in FIG. 14, the first bounding box and the second bounding box are projected in the first direction (direction 1 and direction 2) and the second direction (direction 3 and direction 4). The first bounding box does not collide the second bounding box because the projection regions of the first bounding box and the second bounding box do not overlap in the direction 2 and direction 4.

It should be noted that it is necessary to project any one of the second bounding boxes of the original target object and the first bounding boxes of the dynamic virtual elements in each of the determined directions, and then detect whether the first projection regions are overlapped with the second projection regions in each of the directions. In response to the first projection regions being overlapped with the second projection regions in each of the directions, it is determined that the first bounding boxes collide with the second bounding boxes.

In the embodiment of the present disclosure, the direction perpendicular to the direction of each side of each of the first bounding boxes and the direction perpendicular to the direction of each side of each of the second bounding boxes are determined, and the first bounding boxes and the second bounding boxes are projected to each of the determined directions. In response to the first projection regions and the second projection regions being not overlapped in any one of the directions, it indicates that the first bounding boxes and the second bounding boxes are separated in these directions, that is, it indicates that no collision occurs between the two bounding boxes. In response to the first bounding boxes and the second bounding boxes being overlapped in each of the directions, it indicates that a direction in which the first bounding boxes may be separated front the second bounding boxes does not exist, that is, it indicates that a collision occurs between the two bounding boxes. Therefore, the method defined above may accurately determine whether the first bounding boxes collide with the second bounding boxes.

It should be noted that the collision detection method described in the above-mentioned processes (C) and (D) is merely for a purpose of exemplary illustration. In other embodiments, whether the first bounding boxes collide with the second bounding boxes may be detected by other fashions.

In some embodiments, prior to the collision detection, the first bounding boxes of the dynamic virtual elements are first acquired. That is, the electronic device identifies reference contour points corresponding to the dynamic virtual elements in the video picture; and creates one first bounding box based on each two adjacent reference contour points. Herein, the reference contour points are all or part of the contour points on the contour line of the dynamic virtual elements.

It should be noted that a method for creating the first bounding boxes by the electronic device is the same as the method for creating the second bounding boxes, the details of which are not repeated here.

In the embodiments of the present disclosure, one bounding box is created based on each two adjacent reference contour points among the plurality of reference contour points, and then a plurality of bounding boxes may be created for the dynamic virtual elements. The plurality of bounding boxes may well fit the contour of the dynamic virtual elements. Therefore, based on a result of the collision detection performed on the plurality of bounding boxes, whether the dynamic virtual elements collide with the original target object in the video picture may be accurately reflected, which ensures the accuracy of the collision detection result and improves the precision of the collision detection.

It should be additionally noted that, in some embodiments, in the case that the dynamic virtual elements are added into the video picture with reference to a motion trajectory and the bounding boxes of the dynamic virtual elements in a first frame of video picture are determined, the bounding boxes of the dynamic virtual elements in each of the following frames of video pictures are determined based on the motion trajectory of the dynamic virtual elements. It is unnecessary to create the bounding boxes in each frame of video picture by means of identifying the contour points. Therefore, the efficiency in determining the bounding boxes of the dynamic virtual elements is greatly improved, which increases the efficiency of collision detection.

It should be further noted that detecting the collisions between the first bounding boxes and any one of the second bounding boxes by the electronic device in the case that the dynamic virtual elements are provided with a plurality of first bounding boxes includes: detecting the collisions between each of the first bounding boxes and each of the second bounding boxes by the electronic device. That is, the electronic device detects the collisions between any one of the first bounding boxes and any one of the second bounding boxes. In some embodiments, the electronic device selects the first bounding boxes from the plurality of first bounding boxes in sequence, and detects the collisions between the selected first bounding boxes and the plurality of second hounding boxes.

In 305, the electronic device determines that the original target object collides with the dynamic virtual elements in response to the first bounding boxes colliding with any one of the second bounding boxes.

It should be noted that, in the case that the dynamic virtual elements are provided with the plurality of first bounding boxes, the electronic device determines that the original target object collides with the dynamic virtual elements in response to any one of the first bounding boxes colliding with any one of the second bounding boxes.

In some embodiments, in response to determining that the original target object collides with the dynamic virtual elements, the electronic device adds other virtual elements corresponding to the original target object and the dynamic virtual elements into the video picture. For example, in response to the original target object being an individual, and the dynamic virtual element being a sticker marked with a word “Fat,” a special effect of tears is added to the individual in the video picture in the case that it is determined that the individual collides with the sticker. For another example, in response to the original target object being a balloon, and the dynamic virtual element being a nail, a special effect of balloon bursting and the like is added to the video picture in the case that it is determined that the balloon collides with the nail. This is not limited in the embodiment of the present disclosure.

In the related art, in the case that the collision between the two objects in the video picture is detected, the bounding boxes of the two objects are to be acquired, with each bounding box containing one object therein. The collision detection is performed on the bounding boxes of the two objects, and in response to the two bounding boxes colliding, it is determined that two objects collide. Herein, the bounding boxes refer to regions containing the objects, and all parts of the objects are disposed in these bounding boxes. However, the bounding boxes of the objects cannot accurately fit the contours of the objects and some edge portions of the bounding boxes may contain some regions that are not part of the objects. Although it is detected that the two bounding boxes collide, the two objects may not collide with each other because of the blank edge portions. Therefore, the precision of collision detection of the solution described above is low.

In the embodiment of the present disclosure, one bounding box is created based on each two adjacent target contour points of the target contour targets among a plurality of target contour points, and then a plurality of bounding boxes are created for the original target object. The plurality of bounding boxes can fit the original target object well because they are created based on the contour points of the original target object. Therefore, based on a result of the collision detection performed on the plurality of bounding boxes, whether the original target object collides with the dynamic virtual elements added in the video picture may be accurately reflected, which improves or ensures the accuracy of the collision detection result.

According to one aspect of the present disclosure, a method performed by a processor of an electronic device to process a video is provided. The video comprises a video picture that includes an original target object. The method comprising: adding a first dynamic virtual element to the video picture; acquiring first bounding boxes of the first dynamic virtual element; identifying target contour points corresponding to the original target object, wherein the target contour points are positioned on a contour line of the original target object; creating a plurality of second bounding boxes of the original target object based on each two adjacent target contour points of the target contour target; detecting a collision between the first bounding boxes and the plurality of second bounding boxes; and determining that the first dynamic virtual element is colliding with the original target object in response to the first bounding boxes of the first dynamic virtual element being collided with any of the second bounding boxes of the original target object. In some embodiments, the method further comprises adding a second dynamic virtual element into the video picture in response to the determination that the first dynamic virtual element is colliding with the original target object. In some embodiments, the second dynamic virtual element is configured to create, in the video picture, a special effect that is designated to respond the collision of the first dynamic virtual element with the original target object. Because the collision between the original target object with the first dynamic virtual element can be determined more accurately using the method of the present disclosure, the second dynamic virtual element can be added at the right timing. That is, the second dynamic virtual element can appear in the video picture at the correct timing to avoid displaying erroneous addition when the collusion between the first dynamic virtual element and the original target object does not actually occur.

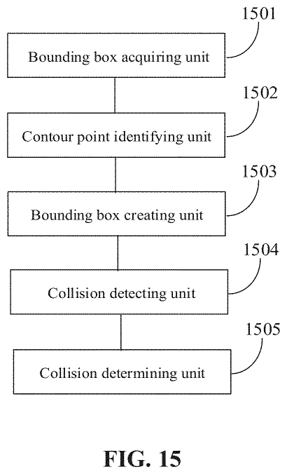

FIG. 15 illustrates a block diagram of an apparatus for detecting collisions in a video according to an embodiment of the present disclosure. As shown in FIG. 15, the apparatus for detecting the collisions in the video includes:
a bounding box acquiring unit 1501, configured to acquire first bounding boxes of dynamic virtual elements, wherein the dynamic virtual elements are added into a video picture;
a contour point recognizing unit 1502, configured to identify target contour points corresponding to an original target object in the video picture, wherein the target contour points are positioned on a contour line of the original target object;
a bounding box creating unit 1503, configured to create one second hounding box based on each two adjacent target contour points of the target contour targets; and
a collision detecting unit 1504, configured to detect collisions between the first bounding boxes and the second bounding boxes.

In some embodiments, the apparatus further includes:
a collision determining unit 1505, configured to determine that the dynamic virtual elements collide with the original target object in response to the first bounding boxes colliding with any one of the second bounding boxes.

In some embodiments, the contour point recognizing unit 1502 includes:
a contour point searching sub-unit, configured to determine pixel points, satisfying a contour condition, in the video picture as original contour points; and
a contour point extracting sub-unit, configured to extract a second reference number of the target contour points every a first reference number of the original contour points.

In some embodiments, the contour point searching sub-unit is configured to: traverse the pixel points in the video picture; determine a currently traversed pixel point as a first original contour point in response to the currently traversed pixel point being a pixel point corresponding to the original target object, and a previously traversed pixel point adjacent to the currently traversed pixel point being not the pixel point corresponding to the original target object; and continue to search for other original contour points based on the first original contour point.

In some embodiments, the contour point searching sub-unit is configured to: traverse the pixel points along the first reference direction from any one of the pixel points, among pixel points in eight neighborhoods of the first original contour point, and determine, a currently traversed pixel point, satisfying the contour condition, as the end point; traverse the pixel points along the second reference direction from the first pixel point, among the pixel points in the eight neighborhoods of the first original contour point, and determine a currently traversed pixel point, satisfying the contour condition, as a second original contour point, wherein the first pixel point is a pixel point reached by moving along the second reference direction from the end point, among the pixel points in the eight neighborhoods of the first original contour point; perform the following processes cyclically: traversing the pixel points along the second reference direction from the second pixel point, among the pixel points in the eight neighborhoods of the currently determined original contour point, determining a currently traversed pixel point, satisfying the contour condition, as the next original contour point, and slopping the cycles in response to the determined next original contour point being the end point, wherein the second pixel point is a pixel point reached by moving along the second reference direction from the previous original contour point, among the pixel points in the eight neighborhoods of the currently determined original contour point. Here the first reference direction and the second reference direction are both a clockwise or counterclockwise direction, and the second reference direction is different from the first reference direction.

In some embodiments, the contour point searching sub-unit is configured to: traverse the pixel points along the first reference direction from any one of the pixel points, among pixel points in eight neighborhoods of the first original contour point, and determine a currently traversed pixel point, satisfying the contour condition, as the second original contour point, wherein the first reference direction is the clockwise or counterclockwise direction; perform the following processes cyclically: traversing the pixel points along the first reference direction from the second pixel point, among the pixel points in the eight neighborhoods of the currently determined original contour point, determining a currently traversed pixel point, satisfying the contour condition, as the next original contour point, and stopping the cycles in response to the currently traversed pixel point being the first original contour point, wherein the second pixel point is a pixel point reached by moving along the first reference direction from the previous original contour point, among the pixel points in the eight neighborhoods of the currently determined original contour point.

In some embodiments, the contour point recognizing unit 1502 is configured to: binarize the video picture to acquire a mask, wherein pixel values of pixel points corresponding to the original target object in the mask are defined as first pixel values; and identify the target contour points among the pixel points of the mask.

In some embodiments, the bounding box creating unit 1503 is configured: determine a distance between two adjacent target contour points as a first side length of a rectangle, and determine a reference distance as a second side length of the rectangle; and create one second bounding box in a rectangular shape based on the first side length and the second side length, wherein the two adjacent target contour points are respectively disposed at center positions of opposite sides of the second bounding box.

In some embodiments, the bounding box acquiring unit 1501 is configured to identify reference contour points corresponding to the dynamic virtual elements, wherein the reference contour points are positioned on a contour line of the dynamic virtual elements; and create one first hounding box based on each two adjacent reference contour points.

The collision detecting unit 1504 is configured to detect the collisions between any one of the first bounding boxes and any one of the second bounding boxes.

In some embodiments, the collision detecting unit 1504 is configured to determine a direction perpendicular to the direction of each side of each of the first bounding boxes and a direction perpendicular to the direction of each side of each of the second bounding boxes; project the first bounding boxes and the second bounding boxes to each of the determined directions; and determine that the first bounding boxes collide with the second bounding boxes in response to first projection regions and second projection regions being overlapped in each of the directions, wherein the first projection regions are defined as projection regions of the first bounding boxes and the second projection regions are defined as projections regions of the second bounding boxes.

In the embodiment of the present disclosure, one bounding box is created based on each two adjacent target contour points of the target contour targets, and then a plurality of bounding boxes may be created for the original target object. The plurality of bounding boxes may fit the original target object well. Therefore, based on a result of the collision detection performed on the plurality of bounding boxes, whether the original target object collides with the dynamic virtual elements in the video picture may be accurately reflected, which ensures the accuracy of the collision detection result and improves the precision of the collision detection.

It should be noted that the apparatus for detecting the collisions in the video provided by the above embodiments only takes division of all the functional modules as an example for explanation during the processing of the video. In some embodiments, the above functions may be finished by the different functional modules as required. That is, the internal structure of the electronic device is divided into different functional modules to finish all or part of the functions described above. In addition, the apparatus for detecting the collisions in the video provided by the above embodiments is derived from the same concept as the method for detecting the collisions in the video provided by the above embodiment. Reference may be made to the method embodiment for the specific implementation process, which is not repeated here.

An embodiment of the present disclosure further provides an electronic device. The electronic device includes: one or more processors, and a volatile or non-volatile memory configured to store one or more instructions executable by the one or more processors. The one or more processors, when loading and executing the one or more instructions, are caused to perform:
acquiring first bounding boxes of dynamic virtual elements, wherein the dynamic virtual elements are added into a video picture;
identifying target contour points corresponding to an original target object in the video picture, wherein the target contour points are positioned on a contour line of the original target object;
creating one second bounding box based on each two adjacent target contour points of the target contour targets; and
detecting collisions between the first bounding boxes and the second bounding boxes.

In some embodiments, the one or more processors, when loading and executing the one or more instructions, are further caused to perform:
determining that the dynamic virtual elements collide with the original target object in response to the first bounding boxes colliding with any one of the second bounding boxes.

In some embodiments, the one or more processors, when loading and executing the one or more instructions, are further caused to perform:
determining pixel points, satisfying a contour condition, in the video picture as original contour points; and
extracting a second reference number of the target contour points every a first reference number of the original contour points.

In some embodiments, the one or more processors, when loading and executing the one or more instructions, are further caused to perform:
traversing the pixel points in the video picture;
determining a currently traversed pixel point as a first original contour point in response to the currently traversed pixel point being a pixel point corresponding to the original target object, and a previously traversed pixel point adjacent to the currently traversed pixel point being not the pixel point corresponding to the original target object; and
continuing to search for other original contour points based on the first original contour point.

In some embodiments, the one or more processors, when loading and executing the one or more instructions, are further caused to perform:
traversing pixel points along a first reference direction from any one of the pixel points, among pixel points in eight neighborhoods of the first original contour point, and determining a currently traversed pixel point, satisfying the contour condition, as an end point;
traversing the pixel points along a second reference direction from a first pixel point, among the pixel points in the eight neighborhoods of the first original contour point, and determining a currently traversed pixel point, satisfying the contour condition, as a second original contour point, wherein the first pixel point is a pixel point reached by moving along the second reference direction from the end point, among the pixel points in the eight neighborhoods of the first original contour point; and
performing the following processes cyclically:
traversing the pixel points along the second reference direction from a second pixel point, determining a currently traversed pixel point, among the pixel points in the eight neighborhoods of the currently determined original contour point, satisfying the contour condition, as a next original contour point, and stopping the cycles in response to the determined next original contour point is the end point, wherein the second pixel point is a pixel point reached by moving along the second reference direction from a previous original contour point, among the pixel points in the eight neighborhoods of the currently determined original contour point,
wherein the first reference direction and the second reference direction are both a clockwise or counterclockwise direction, and the second reference direction is different from the first reference direction.

In some embodiments, the one or more processors, when loading and executing the one or more instructions, are further caused to perform:
traversing pixel points in eight neighborhoods of the firs original contour point along a first reference direction front any one of the pixel points, and determining a currently traversed pixel point, among pixel points in eight neighborhoods of the first original contour point, satisfying the contour condition, as a second original contour point, wherein the first reference direction is a clockwise or counterclockwise direction; and
performing the following processes cyclically:
traversing the pixel points along the first reference direction from a second pixel point, among the pixel points in the eight neighborhoods of the currently determined original contour point, determining a currently traversed pixel point, satisfying the contour condition, as a next original contour point, and stopping the cycles in response to the currently traversed pixel point being the first original contour point, wherein the second pixel point is a pixel point reached by moving along the first reference direction from a previous original contour point, among the pixel points in the eight neighborhoods of the currently determined original contour point.

In some embodiments, the one or more processors, when loading and executing the one or more instructions, are further caused to perform:
binarizing the video picture to acquire a mask, wherein pixel values of pixel points corresponding to the original target object in the mask are defined as first pixel values; and
identifying the target contour points among the pixel points of the mask.

In some embodiments, the one or more processors, when loading and executing the one or more instructions, are further caused to perform:
determining a distance between two adjacent target contour points as a first side length of a rectangle, and determining a reference distance as a second side length of the rectangle; and
creating one second bounding box in a rectangular shape based on the first side length and the second side length, wherein the two adjacent target contour points are respectively disposed at center positions of opposite sides of the second bounding box.

In some embodiments, the one or more processors, when loading and executing the one or more instructions, are further caused to perform:
identifying reference contour points corresponding to the dynamic virtual elements, wherein the reference contour points are positioned on a contour line of the dynamic virtual elements;
creating one first bounding box based on each two adjacent reference contour points; and
detecting the collisions between the first bounding boxes and the second bounding boxes includes:
detecting the collisions between any one of the first bounding boxes and any one of the. second bounding boxes.

In some embodiments, the one or more processors, when loading and executing the one or more instructions, are further caused to perform:
determining a direction perpendicular to a direction of each side of each of the first bounding boxes, and a direction perpendicular to a direction of each side of each of the second bounding boxes;
projecting the first bounding boxes and the second bounding boxes into each of the determined directions; and.
determining that the first bounding boxes collide with the second bounding boxes in response to first projection regions and second projection regions being overlapped in each of the directions, wherein the first projection regions are defined as projection regions of the first bounding boxes; and the second projection regions are defined as projection regions of the second bounding boxes.

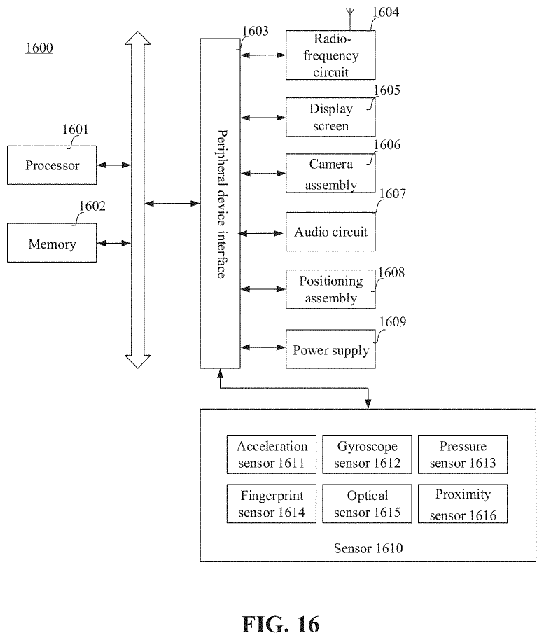

In some embodiments, the electronic device may be provided as a terminal. FIG. 16 illustrates a schematic structural diagram of a terminal 1600 according to an embodiment of the present disclosure. The terminal 1600 may be: a smart phone, a moving picture experts group audio layer III (MP3) player, a moving picture experts group audio layer IV (MP4) player, a laptop computer, or a desktop computer. The terminal 1600 may also be referred to as a user device, a portable terminal, a laptop terminal, a desktop terminal and other names.

The device 1600 includes a processor 1601 and a memory 1602.

The processor 1601 may include one or more processing cores, such as 4-core processors or 8-core processors. The processor 1601 may be implemented in at least one of hardware forms including a digital signal processor (DSP), a field-programmable gate array (FPGA), and a programmable logic array (PLA). The processor 1601 may further include a main processor and a co-processor. The main processor is configured to process data in an awake state, also called as a central processing unit (CPU); and the co-processor is a low-power-consumption processor configured to process data in a standby state. In some embodiments, the processor 1601 may be integrated with a graphic processing unit (GPU) which is configured to render and draw content that is to be displayed on a display screen. In some embodiments, the processor 1601 may further include an Artificial Intelligence (AI) processor, which is configured to process computing operations related to machine learning.

The memory 1602 may include one or more computer-readable storage media, which may be non-transitory. The memory 1602 may further include a high-speed random-access memory, and a non-volatile memory, such as one or more magnetic-disk storage devices and flash storage devices. In some embodiments, the non-transitory computer-readable storage medium in the memory 1602 is configured to store at least one program code, which is configured to be executed by the processor 1601 for performing the method for detecting the collisions in the video according to the method embodiments of the present disclosure.

In some embodiments, the terminal 1600 may further optionally include a peripheral device interface 1603 and at least one peripheral device. The processor 1601, the memory 1602, and the peripheral device interface 1603 may be connected to each other via buses or signal lines. Each of the peripheral devices may be connected to the peripheral device interface 1603 via a bus, a signal line or a circuit board. Specifically, the peripheral device includes at least one of a radio-frequency circuit 1604, a display screen 1605, a camera assembly 1606, an audio circuit 1607, a positioning assembly 1608, and a power supply 1609.

The peripheral device interface 1603 may be configured to connect at least one peripheral device related to input/output (I/O) to the processor 1601 and the memory 1602. In some embodiments, the processor 1601, the memory 1602 and the peripheral device interface 1603 are integrated on the same chip or circuit board. In some other embodiments, any one or two of the processor 1601, the memory 1602 and the peripheral device interface 1603 may be implemented on a separate chip or circuit board, which is not limited in this embodiment.

The radio-frequency circuit 1604 is configured to receive and transmit radio frequency (RF) signals, which are also called electromagnetic signals. The radio-frequency circuit 1604 communicates with a communication network and other communication devices via the electromagnetic signals. The radio-frequency circuit 1604 converts electrical signals into electromagnetic signals for transmission, or converts received electromagnetic signals into electrical signals. For example, the radio-frequency circuit 1604 includes an antenna system, an RF transceiver, one or more amplifiers, a tuner, an oscillator, a digital signal processor, a codec chipset, a user identity module card, etc. The radio-frequency circuit 1604 may communicate with other terminals via at least one wireless communication protocol. The wireless communication protocol includes but is not limited to, a metropolitan area network, various generations of mobile communication networks (2G, 3G, 4G, and 5G), a wireless local area network and/or a wireless fidelity (Wi-Fi)) network. In some embodiments, the radio-frequency circuit 1604 may further include a circuit related to near-field communication (NFC), which is not limited in the present disclosure.

The display screen 1605 is configured to display a user interface (UI). The UI may include graphics, text, icons, videos, and any combination thereof. In the case that the display screen 1605 is a touch display screen, the display screen 1605 is further capable of acquiring a touch signal on or over a surface of the display screen 1605. The touch signal may be input, as a control signal, into the processor 1601 to be processed. At this point, the display screen 1605 may be further configured to provide virtual buttons and/or a virtual keyboard, which is/are also referred to as soft buttons and/or a soft keyboard. In some embodiments, one display screen 1605 may be disposed on a front panel of the terminal 1600. In some other embodiments, at least two display screens 1605 may be disposed on different surfaces of the terminal 1600 or in a folded fashion in still other embodiments, the display screen 1605 may be a flexible display screen disposed on a curved surface or collapsible plane of the terminal 1600. The display screen 1605 may also be even set to an irregular shape other than rectangle, i.e., an irregularly-shaped screen. The display screen 1605 may be made front materials such as a liquid crystal display (LCD) and an organic light-emitting diode (OLED).

The camera assembly 1606 is configured to capture images or videos. For example, the camera assembly 1606 includes a front camera and a rear camera. The front camera is disposed on a front panel of the terminal, and the rear camera is disposed on the back of the terminal. In some embodiments, at least two rear cameras are disposed, each of which is at least one of a main camera, a depth-of-field camera, a wide-angle camera, and a telephoto camera, so as to realize the fusion of the main camera and the depth-of-field camera for background blurring function, the fusion of the main camera and the wide-angle camera for panoramic shooting and virtual reality (VR) shooting functions, or other fusion shooting effects. In some embodiments, the camera assembly 1606 may further include a flashlight. The flashlight may be a monochromatic-temperature flashlight or a dichromatic-temperature flashlight. The dichromatic-temperature flashlight refers to a combination of a warm-light flashlight and a cold-light flashlight, and may serve to compensate light at different chromatic temperatures.

The audio circuit 1607 may include a microphone and a speaker. The microphone is configured to collect sound waves from users and environments, and convert the sound waves into electrical signals, which are then input to the processor 1601 to be processed, or input to the radio-frequency circuit 1604 for voice communication. For the purposes of stereo acquisition or noise reduction, a plurality of microphones may be provided, and disposed on different parts of the terminal 1600. The microphone may also be an array microphone or an omnidirectional acquisition type microphone. The speaker is configured to convert electrical signals from the processor 1601 or the radio-frequency circuit 1604 into sound waves. The speaker may be a traditional thin-film speaker or a piezoelectric ceramic speaker. In the case that speaker is the piezoelectric ceramic speaker, the electrical signals may be converted into sound waves not only audible to human beings, but also inaudible to human beings for distance measurement and other purposes. In some embodiments, the audio circuit 1607 may further include a headphone jack.

The positioning assembly 1608 is configured to position a current geographic location of the terminal 1600 to implement navigation or a location based service (LBS). The positioning assembly 1608 may be the United States' Global Positioning System (GPS), Russia's Global Navigation Satellite System (GLONASS), China's BeiDou Navigation Satellite System (BDS), and the European Union's Galileo Satellite Navigation System (Galileo).

The power supply 1609 is configured to supply power to each of the assemblies in the terminal 1600. The power supply 1609 may be an alternating-current power supply, a direct-current power sully, a disposable battery, or a rechargeable battery. In the case that the power supply 1609 includes a rechargeable battery, the rechargeable battery may support wired charging or wireless charging. The rechargeable battery may be further configured to support the quick charge technology.

In some embodiments, the terminal 1600 may further include one or more sensors 1610. The one or more sensors 1610 include, but are not limited to, an acceleration sensor 1611, a gyroscope sensor 1612, a pressure sensor 1613, a fingerprint sensor 1614, an optical sensor 1615, and a proximity sensor 1616.

The acceleration sensor 1611 may detect the magnitudes of accelerations on three coordinate axes of a coordinate system established based on the terminal 1600. For instance, the acceleration sensor 1611 may be configured to detect components of gravitational acceleration on three coordinate axes. The processor 1601 may control a display screen 1605 to display a user interface in a landscape view or a portrait view based on a gravity acceleration signal captured by the acceleration sensor 1611. The acceleration sensor 1611 may be further configured to capture motion data of a game or a user.

The gyroscope sensor 1612 may detect an orientation and a rotation angle of the body of the terminal 1600, and may capture 3D motions of a user on the terminal 1600 in cooperation with the acceleration sensor 1611. The processor 1601 may implement the following functions based on data acquired by the gyroscope sensor 1612: motion sensing (for example, changing the UI based on a user's tilt operation), image stabilization during shooting, game control, and inertial navigation.

The pressure sensor 1613 may be disposed on a side frame of the terminal 1600 and/or at a lower layer of the display screen 1605. In the case that the pressure sensor 1613 is disposed on the side frame of the terminal 1600, a user's holding signal to the terminal 1600 may be detected, and the processor 1601 performs left-tight hand recognition or shortcut operation based on the holding signal acquired by the pressure sensor 1613. In the case that the pressure sensor 1613 is disposed at the lower layer of the display screen 1605, the processor 1601 controls operable controls on the UI based on a user's press operation on the display screen 1605. The operable controls include at least one of a button control, a scroll bar control, an icon control, and a menu control.

The fingerprint sensor 1614 is configured to capture a user's fingerprint. The processor 1601 recognizes the user's identity based on the fingerprint acquired by the fingerprint sensor 1614, or the fingerprint sensor 1614 recognizes the user's identity based on the captured fingerprint. In the case that the user's identity is recognized as trusted, the processor 1601 authorizes the user to perform relevant sensitive operations, which include unlocking the screen, viewing encrypted information, downloading software, paying, changing settings, etc. The fingerprint sensor 1614 may be disposed on the front, back or side of the terminal 1600. In the case that a physical button or a manufacturer's logo is disposed on the terminal 1600, the fingerprint sensor 1614 may be integrated with the physical button or the manufacturer's logo.

The optical sensor 1615 is configured to capture the intensity of ambient light. In an embodiment, the processor 1601 may control the display brightness of the display screen 1605 based on the intensity of ambient light captured by the optical sensor 1615. Specifically, in the case that the intensity of ambient light is high, the display brightness of the display screen 1605 is increased, and the intensity of ambient light is low, the display brightness of the display screen 1605 is decreased. In another embodiment, the processor 1601 may also dynamically adjust shooting parameters of the camera assembly 1606 based on the intensity of ambient light captured by the optical sensor 1615.

The proximity sensor 1616, also referred to as a distance sensor, is disposed on the front panel of the terminal 1600. The proximity sensor 1616 is configured to capture a distance between a user and the front of the terminal 1600. In an embodiment, in response to the proximity sensor 1616 detecting that the distance between the user and the front of the terminal 1600 gradually decreases, the processor 1601 controls the display screen 1605 to switch from an on state to an off state, and in response to the proximity sensor 1616 detecting the distance between the user and the front of the terminal 1600 gradually increases, the processor 1601 controls the display screen 1605 to switch from the off state to the on state.

Those skilled in the art can understand that the terminal 1600 is not limited by the structure illustrated in FIG. 16, and may include more or fewer assemblies than those illustrated, or a combination of assemblies, or assemblies arranged in a different fashion.

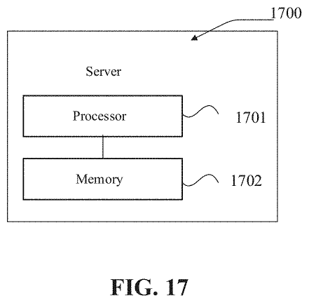

For example, the electronic device is provided as a server. FIG. 17 is a schematic structural diagram of a server according to an embodiment of the present disclosure. The server 1700 may be greatly varied depending on configuration or performance, and may include one or more processors (CPUs) 1701 and one or more memories 1702. The one or more memories 1702 stores/store at least one program code, which, when loaded and executed by the one or more processors 1701, performs the method for detecting the collisions in the video according to the above various method embodiments. The server may further include assemblies such as a wired or wireless network interface, a keyboard, an input/output interface to facilitate input and output, and may further include other assemblies for implementing device functions, the details of which are not repeated here.

In an exemplary embodiment, a computer-readable storage medium, for example, a memory containing at least one program code, is further provided. The at least one program code may be executed by a processor in an electronic device to perform the method for detecting the collisions in the video according to the embodiments described above. For example, the computer-readable storage medium may be a read-only memory (ROM), a random-access memory (RAM), a compact disc read-only memory (CD-ROM), a magnetic tape, a floppy disk, an optical data storage device, or the like.

An embodiment of the present disclosure further provides a computer-readable storage medium storing one or more instructions therein. The one or more instructions, when loaded and executed by a processor of an electronic device, cause the electronic device to perform:
acquiring first hounding boxes of dynamic virtual elements, wherein the dynamic virtual elements are added into a video picture;
identifying target contour points corresponding to an original target object in the video picture, wherein the target contour points are positioned on a contour line of the original target object;
creating one second bounding box based on each two adjacent target contour points of the target contour targets; and
detecting collisions between the first bounding boxes and the second bounding boxes.

In some embodiments, the one or more instructions, when loaded and executed by the processor of the electronic device, further cause the electronic device to perform:
determining that the dynamic virtual elements collide with the original target object in response to the first bounding boxes colliding with any one of the second bounding boxes.

In some embodiments, the one or more instructions, when loaded and executed by the processor of the electronic device, further cause the electronic device to perform:
determining pixel points, satisfying a contour condition, in the video picture as original contour points; and
extracting a second reference number of the target contour points every a first reference number of the original contour points.

In some embodiments, the one or more instructions, when loaded and executed by the processor of the electronic device, further cause the electronic device to perform:
traversing the pixel points in the video picture;
determining a currently traversed pixel point as a first original contour point in response to the currently traversed pixel point being a pixel point corresponding to the original target object, and a previously traversed pixel point adjacent to the currently traversed pixel point being not the pixel point corresponding to the original target object; and
continuing to search for other original contour points based on the first original contour point.

In some embodiments, the one or more instructions, when loaded and executed by the processor of the electronic device, further cause the electronic device to perform:
traversing pixel points in eight neighborhoods of the first original contour point along a first reference direction from any one of the pixel points, and determining a currently traversed pixel point, that satisfies the contour condition, as an end point;
traversing the pixel points along a second reference direction from a first pixel point, among the pixel points in the eight neighborhoods of the first original contour point, and determining a currently traversed pixel point, satisfying the contour condition, as a second original contour point, wherein the first pixel point is a pixel point reached by moving along the second reference direction from the end point, among the pixel points in the eight neighborhoods of the first original contour point; and
performing the following processes cyclically:
traversing the pixel points along the second reference direction from a second pixel point, among the pixel points in the eight neighborhoods of the currently determined original contour point, determining a currently traversed pixel point, satisfying the contour condition, as a next original contour point, and stopping the cycles in response to the determined next original contour point being the end point, wherein the second pixel point is a pixel point reached by moving along the second reference direction from a previous original contour point, among the pixel points in the eight neighborhoods of the currently determined original contour point,
wherein the first reference direction and the second reference direction are both a clockwise or counterclockwise direction, and the second reference direction is different from the first reference direction.

In some embodiments, the one or more instructions, when loaded and executed by the processor of the electronic device, further cause the electronic device to perform:
traversing pixel points along a first reference direction from any one of the pixel points, among pixel points in eight neighborhoods of the first original contour point, and determining a currently traversed pixel point, satisfying the contour condition, as a second original contour point, wherein the first reference direction is a clockwise or counterclockwise direction; and
performing the following processes cyclically:
traversing the pixel points along the first reference direction from a second pixel point, among the pixel points in the eight neighborhoods of the currently determined original contour point, determining a currently traversed pixel point, satisfying the contour condition, as a next original contour point, and stopping the cycles in response to the currently traversed pixel point being the first original contour point, wherein the second pixel point is a pixel point reached by moving along the first reference direction from a previous original contour point, among the pixel points in the eight neighborhoods of the currently determined original contour point.

In some embodiments, the one or more instructions, when loaded and executed by the processor of the electronic device, further cause the electronic device to perform:
binarizing the video picture to acquire a mask, wherein pixel values of pixel points corresponding to the original target object in the mask are defined as first pixel values; and
identifying the target contour points among the pixel points of the mask.

In some embodiments, the one or more instructions, when loaded and executed by the processor of the electronic device, further cause the electronic device to perform:
determining a distance between two adjacent target contour points as a first side length of a rectangle, and determining a reference distance as a second side length of the rectangle; and
creating one second bounding box in a rectangular shape based on the first side length and the second side length, wherein the two adjacent target contour points are respectively disposed at center positions of opposite sides of the second bounding box.

In some embodiments, the one or more instructions, when loaded and executed by the processor of the electronic device, further cause the electronic device to perform:
identifying reference contour points corresponding to the dynamic virtual elements, wherein the reference contour points are positioned on a contour line of the dynamic virtual elements;
creating one first bounding box based on each two adjacent reference contour points; and
detecting the collisions between the first bounding boxes and the second bounding boxes includes:
detecting the collisions between any one of the first bounding boxes and any one of the second bounding boxes.

In some embodiments, the one or more instructions, when loaded and executed by the processor of the electronic device, further cause the electronic device to perform:
determining a direction perpendicular to a direction of each side of each of the first bounding boxes, and a direction perpendicular to a direction of each side of each of the second bounding boxes;
projecting the first bounding boxes and the second bounding boxes into each of the determined directions; and
determining that the first bounding boxes collide with the second bounding boxes in response to first projection regions and second projection regions being overlapped in each of the directions, wherein the first projection regions are defined as projection regions of the first bounding boxes; and the second projection regions are defined as projection regions of the second bounding boxes.

An exemplary embodiment of the present disclosure further provides a computer program product including one or more computer programs is further provided. The one or more computer programs, when loaded and run by a processor, cause the processor to perform:
acquiring first bounding boxes of dynamic virtual elements, wherein the dynamic virtual elements are added into a video picture;
identifying target contour points corresponding to an original target object in the video picture, wherein the target contour points are positioned on a contour line of the original target object;
creating one second bounding box based on each two adjacent target contour points of the target contour targets; and
detecting collisions between the first bounding boxes and the second bounding boxes.

In some embodiments, the one or more computer programs, when loaded and run by the processor, further cause the processor to perform:
determining that the dynamic virtual elements collide with the original target object in response to the first bounding boxes colliding with any one of the second bounding boxes.

In some embodiments, the one or more computer programs, when loaded and run by the processor, further cause the processor to perform:
determining pixel points, that satisfying a contour condition, in the video picture as original contour points; and
extracting a second reference number of the target contour points every a first reference number of the original contour points.

In some embodiments, the one or more computer programs, when loaded and run by the processor, further cause the processor to perform:
traversing the pixel points in the video picture;
determining a currently traversed pixel point as a first original contour point in response to the currently traversed pixel point being a pixel point corresponding to the original target object, and a previously traversed pixel point adjacent to the currently traversed pixel point being not the pixel point corresponding to the original target object; and
continuing to search for other original contour points based on the first original contour point.

In some embodiments, the one or more computer programs, when loaded and run by the processor, further cause the processor to perform:
traversing pixel points in eight neighborhoods of the first original contour point along a first reference direction from any one of the pixel points, and determining a currently traversed pixel point, that satisfies the contour condition, as an end point;
traversing the pixel points along a second reference direction from a first pixel point, among pixel points in eight neighborhoods of the first original contour point, and determining a currently traversed pixel point, satisfying the contour condition, as a second original contour point, wherein the first pixel point is a pixel point reached by moving along the second reference direction from the end point, among the pixel points in the eight neighborhoods of the first original contour point; and
performing the following processes cyclically:
traversing the pixel points along the second reference direction from a second pixel point, among the pixel points in the eight neighborhoods of the currently determined original contour point, determining a currently traversed pixel point, satisfying the contour condition, as a next original contour point, and stopping the cycles in response to the determined next original contour point being the end point, wherein the second pixel point is a pixel point reached by moving along the second reference direction from a previous original contour point, among the pixel points in the eight neighborhoods of the currently determined original contour point,
wherein the first reference direction and the second reference direction are both a clockwise or counterclockwise direction, and the second reference direction is different from the first reference direction.

In some embodiments, the one or more computer programs, when loaded and run by the processor, further cause the processor to perform:
traversing pixel points along a first reference direction from any one of the pixel points, among pixel points in eight neighborhoods of the first original contour point, and determining a currently traversed pixel point, satisfying the contour condition, as a second original contour point, wherein the first reference direction is a clockwise or counterclockwise direction; and
performing the following processes cyclically:
traversing the pixel points along the first reference direction from a second pixel point, among the pixel points in the eight neighborhoods of the currently determined original contour point, determining a currently traversed pixel point, satisfying the contour condition, as a next original contour point, and stopping the cycles in response to the currently traversed pixel point being the first original contour point, wherein the second pixel point is a pixel point reached by moving along the first reference direction from a previous original contour point, among the pixel points in the eight neighborhoods of the currently determined original contour point.

In some embodiments, the one or more computer programs, when loaded and run by the processor, further cause the processor to perform:
binarizing the video picture to acquire a mask, wherein pixel values of pixel points corresponding to the original target object in the mask are defined as first pixel values; and
identifying the target contour points among the pixel points of the mask.

In some embodiments, the one or more computer programs, when loaded and run by the processor, further cause the processor to perform:
determining a distance between two adjacent target contour points as a first side length of a rectangle, and determining a reference distance as a second side length of the rectangle; and
creating one second bounding box in a rectangular shape based on the first side length and the second side length, wherein the two adjacent target contour points are respectively disposed at center positions of opposite sides of the second bounding box.

In some embodiments, the one or more computer programs, when loaded and run by the processor, further cause the processor to perform:
identifying reference contour points corresponding to the dynamic virtual elements, wherein the reference contour points are positioned on a contour line of the dynamic virtual elements;
creating one first bounding box based on each two adjacent reference contour points; and
detecting the collisions between the first bounding boxes and the second bounding boxes includes:
detecting the collisions between any one of the first bounding boxes and any one of the second bounding boxes.

In some embodiments, the one or more computer programs, when loaded and run by the processor, further cause the processor to perform:
determining a direction perpendicular to a direction of each side of each of the first bounding boxes, and a direction perpendicular to a direction of each side of each of the second bounding boxes;
projecting the first bounding boxes and the second bounding boxes into each of the determined directions; and
determining that the first bounding boxes collide with the second bounding boxes in response to first projection regions and second projection regions being overlapped in each of the directions, wherein the first projection regions are defined as projection regions of the first hounding boxes; and the second projection regions are defined as projection regions of the second bounding boxes.

An exemplary embodiment of the present disclosure further provides a method for detecting collisions in a video. The method includes:
acquiring bounding boxes of dynamic virtual elements, wherein the dynamic virtual elements are added into a video picture;
identifying target contour points corresponding to an original target object in the video picture, wherein the target contour points are all or part of contour points positioned on a contour line of the original target object;
creating one bounding box based on each two adjacent target contour points of the target contour targets to acquire a plurality of bounding boxes of the original target object;
detecting collisions between the bounding boxes of the dynamic virtual elements and each of the bounding boxes of the original target object; and
determining that the dynamic virtual elements collide with the original target object in response to the bounding boxes of the dynamic virtual elements colliding with any one of the bounding boxes of the original target object.

In some embodiments, identifying the target contour points corresponding to the original target object in the video picture includes:
traversing the pixel points in the video picture one by one, and determining pixel points, satisfying the contour condition, among the pixel points in the video picture as original contour points; and
acquiring the target contour points by extracting a second reference number of the target contour points from the searched original contour points every a first reference number of the original contour points.

In some embodiments, acquiring the bounding boxes of the dynamic virtual elements includes:
identifying reference contour points corresponding to the dynamic virtual elements in the video picture, wherein the reference contour points are all or part of contour points positioned on a contour line of the dynamic virtual elements;
acquiring a plurality of bounding boxes of the dynamic virtual elements by creating one bounding box based on each two adjacent reference contour points; and
detecting the collisions between the bounding boxes of the dynamic virtual elements and each of the bounding boxes of the original target object includes:
detecting the collisions between each of the bounding boxes of the dynamic virtual elements and each of the bounding boxes of the original target object.

In some embodiments, detecting the collisions between the bounding boxes of the dynamic virtual elements and each of the bounding boxes of the original target object includes:
determining a first direction perpendicular to a direction of each side of each the bounding boxes of the original target object, and a second direction perpendicular to a direction of each side of each of the bounding boxes of the dynamic virtual elements;
projecting the bounding boxes of the original target object and the bounding boxes of the dynamic virtual elements into a first direction and a second direction; and
determining that the bounding boxes of the original target object collide with the hounding boxes of the dynamic virtual elements, in response to projection regions of the bounding boxes of the original target objects and projection regions of the bounding boxes of the dynamic virtual elements being overlapped in both the first direction and the second direction.

All the embodiments of the present disclosure may be executed individually or in combination with other embodiments, all of which shall be construed as falling within the protection scope of the present disclosure.

What is claimed is:

1. A method for detecting collisions in a video, comprising:
acquiring first bounding boxes of dynamic virtual elements, wherein the dynamic virtual elements are added into a video picture;
identifying target contour points corresponding to an original target object in the video picture, wherein the target contour points are positioned on a contour line of the original target object;
creating a second bounding box based on each two adjacent target contour points of the original target object; and
detecting the collisions between the first bounding boxes and the second bounding boxes to determine whether the dynamic virtual elements collide with the original target.

2. The method for detecting the collisions in the video according to claim 1, further comprising:
determining that the dynamic virtual elements collide with the original target object in response to the first bounding boxes colliding with any one of the second bounding boxes.

3. The method for detecting the collisions in the video according to claim 1, wherein said identifying the target contour points corresponding to the original target object in the video picture comprises:
determining pixel points satisfying a contour condition in the video picture as original contour points; and
extracting a second reference number of the target contour points every a first reference number of the original contour points.

4. The method for detecting the collisions in the video according to claim 3, wherein said determining the pixel points, satisfying the contour condition, in the video picture as the original contour points comprises:
traversing pixel points in the video picture;
determining a currently traversed pixel point as a first original contour point in response to the currently traversed pixel point being a pixel point corresponding to the original target object, and a previously traversed pixel point adjacent to the currently traversed pixel point being not the pixel point corresponding to the original target object; and
continuing to search for other original contour points based on the first original contour point.

5. The method for detecting the collisions in the video according to claim 4, wherein said continuing to search for the other original contour points based on the first original contour point comprises:
traversing pixel points along a first reference direction from any one of the pixel points, among pixel points in eight neighborhoods of the first original contour point, and determining a currently traversed pixel point satisfying the contour condition as an end point;
traversing the pixel points along a second reference direction from a first pixel point, among the pixel points in the eight neighborhoods of the first original contour point, and determining a currently traversed pixel point satisfying the contour condition as a second original contour point, wherein the first pixel point is a pixel point reached by moving along the second reference direction from the end point, among the pixel points in the eight neighborhoods of the first original contour point; and
performing the following processes cyclically:
traversing the pixel points along the second reference direction from a second pixel point, among the pixel points in the eight neighborhoods of the currently determined original contour point, determining a currently traversed pixel point satisfying the contour condition as a next original contour point, and stopping the cycles in response to the determined next original contour point being the end point, wherein the second pixel point is a pixel point reached by moving along the second reference direction from a previous original contour point, among the pixel points in the eight neighborhoods of the currently determined original contour point,
wherein the first reference direction and the second reference direction are a clockwise or counterclockwise direction, and the second reference direction is different from the first reference direction.

6. The method for detecting the collisions in the video according to claim 4, wherein said continuing to search for the other original contour points based on the first original contour point comprises:
traversing pixel points along a first reference direction from any one of the pixel points, among pixel points in eight neighborhoods of the first original contour point, and determining a currently traversed pixel point, satisfying the contour condition, as a second original contour point, wherein the first reference direction is a clockwise or counterclockwise direction; and
performing the following processes cyclically:
traversing the pixel points along the first reference direction from a second pixel point, among the pixel points in the eight neighborhoods of the currently determined original contour point, determining a currently traversed pixel point, satisfying the contour condition, as a next original contour point, and stopping the cycles in response to the currently traversed pixel point being the first original contour point, wherein the second pixel point is a pixel point reached by moving along the first reference direction from a previous original contour point, among the pixel points in the eight neighborhoods of the currently determined original contour point.

7. The method for detecting the collisions in the video according to claim 1, wherein said identifying the target contour points corresponding to the original target object in the video picture comprises:
binarizing the video picture to acquire a mask, wherein pixel values of pixel points corresponding to the original target object in the mask are defined as first pixel values and pixel values of other pixel points are defined as second pixel values; and
identifying the target contour points among the pixel points of the mask.

8. The method for detecting the collisions in the video according to claim 1, wherein said creating one second bounding box based on each two adjacent target contour points of the original target object comprises:
determining a distance between two adjacent target contour points as a first side length of a rectangle, and determining a reference distance as a second side length of the rectangle; and
creating one second bounding box a rectangular shape based on the first side length and the second side length, wherein the two adjacent target contour points are respectively disposed at center positions of opposite sides of the second bounding box.

9. The method for detecting the collisions in the video according to claim 1, wherein said acquiring the first bounding box of the dynamic virtual elements comprises:
identifying reference contour points corresponding to the dynamic virtual elements, wherein the reference contour points are positioned on a contour line of the dynamic virtual elements;
creating one first bounding box based on each two adjacent reference contour points;
said detecting the collisions between the first bounding boxes and the second bounding boxes comprises:
detecting the collisions between any one of the first bounding boxes and any one of the second bounding boxes.

10. The method for detecting the collisions in the video according to claim 1, wherein said detecting the collisions between the first bounding boxes and the second bounding boxes comprises:
determining a direction perpendicular to a direction of each side of each of the first bounding boxes, and a direction perpendicular to a direction of each side of each of the second bounding boxes;
projecting the first bounding boxes and the second bounding boxes into each of the determined directions; and
determining that the first bounding boxes collide with the second bounding boxes in response to first projection regions and second projection regions being overlapped in each of the determined directions, wherein the first projection regions are defined as projection regions of the first bounding boxes; and the second projection regions are defined as projection regions of the second bounding boxes.

11. An electronic device, comprising:
one or more processors;
a volatile or non-volatile memory configured to store one or more instructions executable by the one or more processors,
wherein the one or more processors, when loading and executing the one or more instructions, are caused to perform:
acquiring first bounding boxes of dynamic virtual elements, wherein the dynamic virtual elements are added into a video picture;
identifying target contour points corresponding to an original target object in the video picture, wherein the target contour points are positioned on a contour line of the original target object;
creating one second bounding box based on each two adjacent target contour points of the original target object; and
detecting collisions between the first bounding boxes and the second bounding boxes.

12. The electronic device according to claim 11, wherein the one or more processors, when loading and executing the one or more instructions, are further caused to perform:
determining that the dynamic virtual elements collide with the original target object in response to the first bounding boxes colliding with any one of the second bounding boxes.

13. The electronic device according to claim 11, wherein the one or more processors, when loading and executing the one or more instructions, are further caused to perform:
determining pixel points, satisfying a contour condition, in the video picture as original contour points; and
extracting a second reference number of the target contour points every a first reference number of the original contour points.

14. The electronic device according to claim 13, wherein the one or more processors, when loading and executing the one or more instructions, are further caused to perform:
traversing pixel points in the video picture;
determining a currently traversed pixel point as a first original contour point in response to the currently traversed pixel point being a pixel point corresponding to the original target object, and a previously traversed pixel point adjacent to the currently traversed pixel point being not the pixel point corresponding to the original target object; and
continuing to search for other original contour points based on the first original contour point.

15. The electronic device according to claim 14, wherein the one or more processors, when loading and executing the one or more instructions, are further caused to perform:
traversing pixel points along a first reference direction from any one of the pixel points, among pixel points in eight neighborhoods of the first original contour point, and determining a currently traversed pixel point, that satisfies the contour condition, as an end point;
traversing the pixel points along a second reference direction from a first pixel point, among the pixel points in the eight neighborhoods of the first original contour point, and determining a currently traversed pixel point, that satisfies the contour condition, as a second original contour point, wherein the first pixel point is a pixel point reached by moving along the second reference direction from the end point, among the pixel points in the eight neighborhoods of the first original contour point; and
performing the following processes cyclically:
traversing the pixel points along the second reference direction from a second pixel point, among the pixel points in the eight neighborhoods of the currently determined original contour point, determining a currently traversed pixel point, satisfying the contour condition, as a next original contour point, and stopping the cycles in response to the determined next original contour point being the end point, wherein the second pixel point is a pixel point reached by moving along the second reference direction from a previous original contour point, among the pixel points in the eight neighborhoods of the currently determined original contour point,
wherein the first reference direction and the second reference direction are both a clockwise or counterclockwise direction, and the second reference direction is different from the first reference direction.

16. The electronic device according to claim 14, wherein the one or more processors, when loading and executing the one or more instructions, are further caused to perform:
traversing pixel points along a first reference direction from any one of the pixel points, among pixel points in eight neighborhoods of the first original contour point, and determining a currently traversed pixel point, satisfying the contour condition, as a second original contour point, wherein the first reference direction is a clockwise or counterclockwise direction; and
performing the following processes cyclically:
traversing the pixel points along the first reference direction from a second pixel point, among the pixel points in the eight neighborhoods of the currently determined original contour point, determining a currently traversed pixel point, satisfying the contour condition, as a next original contour point, and stopping the cycles in response to the currently traversed pixel point being the first original contour point, wherein the second pixel point is a pixel point reached by moving along the first reference direction from a previous original contour point, among the pixel points in the eight neighborhoods of the currently determined original contour point.

17. The electronic device according to claim 11, wherein the one or more processors, when loading and executing the one or more instructions, are further caused to perform:
binarizing the video picture to acquire a mask, wherein pixel values of pixel points corresponding to the original target object in the mask are defined as first pixel values; and
identifying the target contour points among the pixel points of the mask.

18. The electronic device according to claim 11, wherein the one or more processors, when loading and executing the one or more instructions, are further caused to perform:
determining a distance between two adjacent target contour points as a first side length of a rectangle, and determining a reference distance as a second side length of the rectangle; and
creating one second bounding box in a rectangular shape based on the first side length and the second side length, wherein the two adjacent target contour points are respectively disposed at center positions of opposite sides of the second bounding box.

19. The electronic device according to claim 11, wherein the one or more processors, when loading and executing the one or more instructions, are further caused to perform:
identifying reference contour points corresponding to the dynamic virtual elements, wherein the reference contour points are positioned on a contour line of the dynamic virtual elements;
creating one first bounding box based on each two adjacent reference contour points; and
said detecting the collisions between the first bounding boxes and the second bounding boxes comprises:
detecting the collisions between any one of the first bounding boxes and any one of the second bounding boxes.

20. A non-transitory computer-readable storage medium storing one or more instructions therein, wherein the one or more instructions, when loaded and executed by a processor of an electronic device, cause the electronic device to perform:
acquiring first bounding boxes of dynamic virtual elements, wherein the dynamic virtual elements are added into a video picture;
identifying target contour points corresponding to an original target object in the video picture, wherein the target contour points are positioned on a contour line of the original target object;
creating one second bounding box based on each two adjacent target contour points of the original target object; and
detecting collisions between the first bounding boxes and the second bounding boxes.
